(19) United States
(12) Patent Application Publication
(10) Pub. No.: US 2022/0011876 A1
(43) Pub. Date: Jan. 13, 2022

(54) SMALL AND PORTABLE INPUT DEVICE WITH FUNCTIONS FOR STARTING AND CONTROLLING DOCUMENT DISPLAY

(71) Applicant: HONGFUJIN PRECISION ELECTRONICS(TIANJIN)CO.,LTD., Tianjin (CN)

(72) Inventors: CHUANG-WEI TSENG, New Taipei (TW); YU-CHING CHIEN, New Taipei (TW); HONG-YI ZENG, Taoyuan (TW)

(21) Appl. No.: 16/987,655

(22) Filed: Aug. 7, 2020

(30) Foreign Application Priority Data
Jul. 8, 2020 (CN) 202010652090.8

(51) Int. Cl. G06F 3/038; G06F 3/023

(52) U.S. Cl. CPC G06F 3/038; G06F 2203/0384; G06F 3/0231

(57) ABSTRACT

A portable and simple input device for document display purposes which can operate with the powers and functions of a full computer includes a cover, keys for user input, a circuit board, a storage unit, a first communication unit, and a processor. The keys are outside the cover, the circuit board, the processor, and the storage unit are within the cover. The storage unit stores a computer operating system and a preset document. The first communication unit enables communication between the input device and an external display device. The processor can generate a starting signal when a first preset condition is met, execute the computer operating system and the preset document in the computer operating system according to the starting signal, transmit the executed preset document to the external display device for display, and control the display characteristics of the preset document.

### FIELD

The subject matter herein generally relates to image displays, and particularly, to an input device encompassing all functions required for display and display control.

### BACKGROUND

To display and manipulate the display of a document, a display unit, a computer, and an input device must be employed and a document in the computer must be firstly projected onto the display unit via operating the input device. The computer and the input device work together and are both required. However, a computer is often something which is large and heavy and difficult to bring into a projection environment. To project a stored document from the computer onto the display unit, cumbersome operations such as, for example, opening a folder, opening the document, and so on, must be executed.

### BRIEF DESCRIPTION OF THE DRAWINGS

Implementations of the present technology will now be described, by way of embodiment, with reference to the attached figures.

FIG. 1 is a block diagram of an input device, an external display device, an external electronic device, and an external cloud platform.

FIG. 2 is a view of the input device of FIG. 1 coupled to the external display device via wires.

FIG. 3 is a view of the input device of FIG. 1 coupled wirelessly to the external display device.

### DETAILED DESCRIPTION

The present disclosure is made in conjunction with corresponding drawings in the embodiments. Obviously, the described embodiments are merely a part of the embodiments of the present disclosure and not all the embodiments. Based on the embodiments of the present disclosure, all other embodiments obtained by those ordinarily skilled in the art without paying creative work fall within the protection scope of the present disclosure.

When one component is considered to “couple” to another component, it may be directly connected to the other component or there may be a third component between them.

Unless otherwise defined, all the technical and scientific terms used in this specification convey the same meanings as the meanings commonly understood by a person skilled in the art. Additionally, the terms used in the specification the present disclosure are merely for describing the objective of the specific embodiments, and are not intended to limit the present disclosure. The term “and/or,” includes any and all combinations of one or more of the associated listed items.

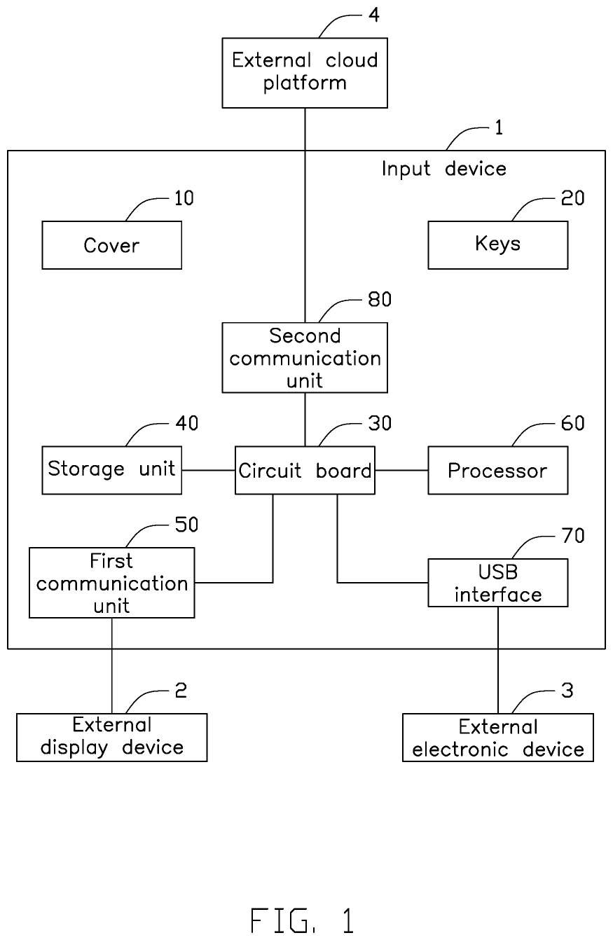

FIG. 1 is a block diagram of an input device 1, an external display device 2, an external electronic device 3, and an external cloud platform 4. The input device 1 includes a cover 10, a number of keys 20, a circuit board 30, a storage unit 40, a first communication unit 50, and a processor 60. The keys 20 are arranged on an external surface of the cover 10. The circuit board 30 is arranged in the cover 10. The storage unit 40 is electrically coupled to the circuit board 30. In the embodiment, the storage unit 40 can include, but is not limited to, a random access memory, an optical disc memory, a disk memory, a tape memory, or any other medium capable of storing various data. The storage unit 40 stores a computer operating system and a preset document. The first communication unit 50 is electrically coupled to the circuit board 30. The first communication unit 50 is configured to enable the input device 1 to communicate with the external display device 2. The processor 60 is electrically coupled to the circuit board 30. The processor 60 can be a central processing unit, a microprocessor, a digital processing chip, or any other processing chip. The processor 60 is configured to generate a starting signal when a first preset condition is met, execute the computer operating system and the preset document in the computer operating system according to the starting signal, and display the executed preset document on the external display device 2 via the first communication unit 50. In the embodiment, the circuit board 30, the storage unit 40, the first communication unit 50, and the processor 60 are fixed in the cover 10. The input device 1 can be a mouse, a keyboard, or other input device. The computer operating system is a micro-computer architecture. The computer operating system can execute a part of function of the standard computer operating system when being executed.

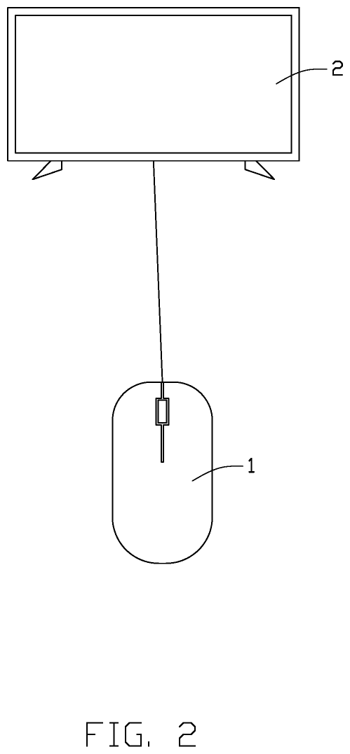

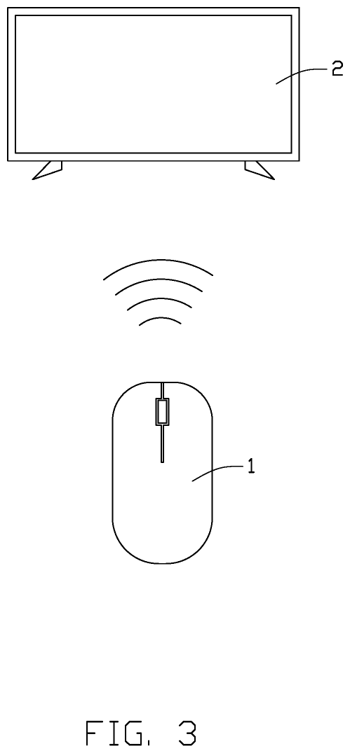

The first preset condition includes the input device 1 being coupled to the external display device 2 via the first communication unit 50. Referring to FIG. 2, the first communication unit 50 is a high-definition multimedia interface (hereinafter HDMI). The first preset condition includes the input device 1 being coupled by wires to the external display device 2 via the HDMI. In detail, the first preset condition includes the input device 1 being coupled by the wires to the external display device 2 via the HDMI and an HDMI wire. FIG. 2 illustrates that the input device 1 is a mouse, but is not restricted thereto. In case the input device 1 is a mouse, the keys 20 can include a mouse wheel in addition to clickable left and right buttons. The input device 1 can also be a keyboard or other small input device with the keys 20. Referring to FIG. 3, the first communication unit 50 can be a wireless local area network communication unit. The storage unit 40 stores software enabling image projections. The first preset condition includes receiving a first preset operation on the keys 20 coupling the input device 1 wirelessly to the external display device 2 via the software enabling the image projections and the wireless local area network communication unit. FIG. 3 illustrates that the input device 1 is a mouse, but without being restricted thereto. The input device 1 can be a keyboard or other input device. In detail, the wireless local area network communication unit is a WIFI unit, a BLUETOOTH unit, a ZIGBEE unit, a Narrow Band Internet of Things unit, or the like. In the embodiment, the first preset operation on the keys 20 includes a first preset operation on the at least one key of the input device 1, for example, a press on a first key and a third key of the input device 1, or the like. Obviously, the present disclosure is not limited to the input device 1 including the HDMI or the wireless local area network communication unit, the input device 1 can include the HDMI and the wireless local area network communication unit.

The first preset condition can include a second preset operation on the keys 20. The second preset operation on the keys 20 can be same or different from the first preset operation on the keys 20. A difference between the second preset operation on the keys 20 and the first preset operation on the keys 20 can be either a button difference or an operation difference. For example, the second preset operation on the keys 20 can be an operation on a second key and the third key, and the first preset operation on the keys 20 can be an operation on the first key only. Or, the second preset operation on the keys 20 can be a wheel-roll on the first key, and the first preset operation on the keys 20 can be a pressing on the first key.

The processor 60 can detect a preset operation on the keys 20, and determine whether the preset operation on the keys 20 is being carried out for a first time. If the first preset condition includes receiving a first preset operation on the keys 20 to cause the input device 1 to be wirelessly coupled to the external display device 2 via the software and the wireless local area network communication unit, the preset operation is the first preset operation. If the first preset condition includes a second preset operation on the keys 20, the preset operation is the second preset operation. If the preset operation on the keys 20 is being carried out for the first time, the processor 60 is configured to generate the starting signal accordingly. If the preset operation on the keys 20 is not being carried out for the first time, the processor 60 is further configured to generate a control signal according to the preset operation on the keys 20, and control display characteristics of the preset document being displayed on the external display device 2 via the first communication unit 50 according to the control signal. The display characteristics of the preset document being displayed on the external display device 2 includes a page up function of the displayed preset document, a page down function of the displayed preset document, and so on.

The input device 1 further includes a USB interface 70. The USB interface 70 is electrically coupled to the circuit board 30. The USB interface 70 is configured to enable the input device 1 to couple to the external electronic device 3 to obtain the preset document from the external electronic device 3. The USB interface 70 is fixed in the cover 10. The external electronic device 3 can be a computer, a smart phone, or the like.

The processor 60 is further configured to generate an operation signal when a second preset condition is met, execute the computer functions of the computer operating system according to the operation signal, and transmit the computer functions to the external display device 2 for the display via the first communication unit 50. The second preset condition includes a third preset operation on the keys 20. The third preset operation on the keys 20 is different from the first and second preset operations on the keys 20. A difference between the third preset operation on the keys 20 and the second preset operation on the keys 20 can be either the button difference or the operation difference. A difference between the third preset operation on the keys 20 and the first preset operation on the keys 20 can be either the button difference or the operation difference. Thus, the input device 1 can function in the manner of a computer, display the function on the external display device 2, and operate and control the display via the input device 1.

The processor 60 is further coupled to the external cloud platform 4 to improve operability of the input device 1. In detail, the input device 1 further includes a second communication unit 80. The second communication unit 80 enables the input device 1 to communicate with the external cloud platform 4. The second communication unit 80 includes a wired communication unit. Obviously, when the first communication unit 50 does not include the WIFI unit, the second communication unit 80 can include the WIFI unit. The processor 60 is further coupled to the external cloud platform 4 to improve the operability of the input device 1 via the wired communication unit or the WIFI unit. Thus, the connection with the external cloud platform 4 improves the operation ability of the input device 1 even if the input device 1 only stores the micro-computer architecture.

The disclosure is not limited to the above embodiment, the operated keys 20 when generating the starting signal can be different from when controlling the display of the preset document. For example, the generation of the starting signal by the operated keys 20 can be sequential pressing a left key of the mouse and a right key of the mouse, and the control of the document display by the operated keys 20 can be pressing just the left key of the mouse or the right key of the mouse. Alternatively, the operation when generating the starting signal can be different from the operation when controlling the display of the preset document displayed on the external display device 2. Thus, determining whether the preset operation on the keys 20 is being carried out for the first time or otherwise is not required. The processor 60 is further configured to generate the control signal according to a fourth preset operation on the keys 20, and control the display of the preset document via the first communication unit 50 according to the control signal.

The disclosure stores the computer operating system and the preset document in the input device 1, executes the computer operating system and the preset document in the computer operating system according to the starting signal when the operation on the input device 1 meets the first preset condition, and transmits the executed preset document to the external display device 2 to be displayed via the first communication unit 50. Thus, a small input device 1 is the only hardware required, a large computer does not need to be brought in to the display room. Simultaneously, the operations on the input device 1 need only to meet the first preset condition to achieve display of the preset document, without further complicated or cumbersome operations.

It should be noted that the above embodiments are merely to illustrate the technical solutions of the present disclosure and are not intended to be limiting. Preferred examples with reference to the present disclosure have been described in detail but a person skilled in the art will understand that the present disclosure may be modified or may be carried out by equivalents without departing from the spirit and scope of the present disclosure.

1. An input device being selected from a group consisting of a mouse and a keyboard, the input device comprising:
a cover;
a plurality of keys arranged on an external surface of the cover;
a circuit board arranged in the cover;
a storage unit coupled to the circuit board, the storage unit storing a computer operating system of a computer and a preset document, the computer operating system having a micro-computer architecture and executing a part of function of the standard computer operating system when executed;
a first communication unit coupled to the circuit board, the first communication unit configured to enable the input device to communicate with an external display device; and
a processor coupled to the circuit board, the processor configured to generate a starting signal when a first preset condition is met, execute the computer operating system of the computer and the preset document in the computer operating system according to the starting signal, and display the executed preset document on the external display device via the first communication unit.

2. The input device according to claim 1, wherein the first preset condition comprises the input device being coupled to the external display device via the first communication unit.

3. The input device according to claim 2, wherein the first communication unit is a high-definition multimedia interface, the first preset condition comprises the input device being coupled by wires to the external display device via the high-definition multimedia interface.

4. The input device according to claim 2, wherein the storage unit stores software enabling image projections, the first communication unit is a wireless local area network communication unit, the first preset condition comprises receiving a first preset operation on the plurality of keys coupling the input device wirelessly to the external display device via the software enabling the image projections and the wireless local area network communication unit.

5. The input device according to claim 1, wherein the first preset condition comprises a second preset operation on the plurality of keys.

6. The input device according to claim 1, wherein:
the processor is configured to detect a preset operation on the plurality of keys, and determine whether the preset operation on the plurality of keys is being carried out for a first time, if the first preset condition comprises receiving a first preset operation on the plurality of keys to cause the input device to be wirelessly coupled to the external display device via software enabling image projections and a wireless local area network communication unit, the preset operation is the first preset operation, if the first preset condition comprises a second preset operation on the plurality of keys, the preset operation is the second preset operation;
the processor is configured to generate the starting signal according to the preset operation on the plurality of keys if the preset operation on the plurality of keys is being carried out for the first time.

7. The input device according to claim 6, wherein:
if the preset operation on the plurality of keys is not being carried out for the first time, the processor is further configured to generate a control signal according to the preset operation on the plurality of keys, and control display characteristics of the preset document being displayed on the external display device via the first communication unit according to the control signal, the display characteristics of the preset document being displayed on the external display device comprising a page up function of the displayed preset document and a page down function of the displayed preset document.

8. The input device according to claim 1, wherein:
the input device further comprises a USB interface, the USB interface is electrically coupled to the circuit board, the USB interface is configured to enable the input device to couple to an external electronic device to obtain the preset document from the external electronic device.

9. The input device according to claim 1, wherein:
the processor is further configured to generate an operation signal when a second preset condition is met, execute computer functions of the computer operating system according to the operation signal, and transmit the computer functions to the external display device for the display via the first communication unit.

10. The input device according to claim 9, wherein the processor is further configured to be coupled to an external cloud platform to improve operability of the input device.
